(19) United States
(12) Patent Application Publication
(10) Pub. No.: US 2011/0237762 A1
(43) Pub. Date: Sep. 29, 2011

(54) Reactor, Process for Producing Prepolymerization Catalyst for Olefin Polymerization, and Process for Producing Olefin Polymer

(75) Inventors: Tomoaki GOTO, Rabigh (SA); Yoichi Masuda, Sodegaura (JP)

(73) Assignee: Sumitomo Chemical Company, Limited, Toyko (JP)

(21) Appl. No.: 13/073,679

(22) Filed: Mar. 28, 2011

(30) Foreign Application Priority Data
Mar. 29, 2010 (JP) 2010-074565

(51) Int. Cl. C08F 2/34; C08F 10/02; B01J 19/00; B01J 27/24

(52) U.S. Cl. 526/75; 422/129; 502/200

(57) ABSTRACT

The present invention relates to a reactor, a process for producing a prepolymerization catalyst for olefin polymerization, and a process for producing an olefin polymer.

A reactor for producing a prepolymerization catalyst for olefin polymerization, said reactor comprising:

a stirring blade; and

a scraper,

wherein said scraper is capable of scraping off a fouling adhered on an inner wall surface of the reactor, and

a portion of the scraper for scraping off at least said fouling is made of a polyolefin.

### CROSS REFERENCE TO RELATED APPLICATIONS

This application claims priority to JP Patent Application No. 2010-074565, filed on Mar. 29, 2010, the entirety of which is incorporated herein by reference.

### FIELD OF THE INVENTION

The present invention relates to a reactor, a process for producing a prepolymerization catalyst for olefin polymerization, and a process for producing an olefin polymer.

### BACKGROUND OF THE INVENTION

Reactors provided with a stirring blade and a scraper are generally known in the art.

For instance, JP-B-5-16898 (published on Mar. 5, 1993) discloses a scraper comprising a flat plate portion contacting with an inner wall surface of a stirring vessel, and a corrugated sheet-like guide plate connected to the flat plate portion and functioning to guide the scraped out fluid, which is designed to improve heat transfer effect.

JP-A-1-301210 (published on Dec. 5, 1989) discloses a scraper made of a fluorine resin.

### SUMMARY OF THE INVENTION

However, in producing a prepolymerization catalyst for olefin polymerization, when the reactor of JP-B-5-16898 or JP-A-1-301210 was used for preventing fouling on the inner wall surface of the reactor, a part of the scraper or inner wall surface of the reactor would be damaged due to contact of the scraper with the inner wall surface of the reactor, and the broken fragments might mix into the prepolymerization catalyst for olefin polymerization produced in the reactor. When the thus contaminated prepolymerization catalyst for olefin polymerization is used for the production of olefin polymers, the fragments could get into the produced olefin polymer. And when the olefin polymer having the said fragments mixed therein was molded, there was a fear of causing degrading of quality of the molded product. When, for instance, the contaminated polymer was made into a film, the fragments would form fish eyes to degrade quality of the film. Thus, request has been voiced for a fouling-free reactor having a scraper which, when used for producing prepolymerization catalysts for olefin polymerization, has no likelihood of damaging the inner wall surface of the reactor, and even when an olefin polymer mixed with the said fragments is molded, the molded product is not deteriorated in its quality.

An object of the present invention is to provide a reactor for producing the prepolymerization catalysts for olefin polymerization, which reactor is capable of preventing fouling on the inner wall surface of the reactor, does not cause damage to its inner wall surface, and when molding an olefin polymer having the broken fragments of scraper mixed therein, does not cause deterioration of quality of the molded product. It is also envisaged in this invention to provide a process for producing the prepolymerization catalysts for olefin polymerization, and a process for producing the olefin polymers by using the above-said prepolymerization catalysts for olefin polymerization.

The present invention provides a reactor for producing a prepolymerization catalyst for olefin polymerization, said reactor comprising:

a stirring blade; and

a scraper,

wherein said scraper is capable of scraping off a fouling adhered on an inner wall surface of the reactor, and

a portion of the scraper for scraping off at least said fouling is made of a polyolefin.

The present invention also provides a method for producing a prepolymerization catalyst for olefin polymerization by using the above reactor, and a method of producing an olefin polymer by using the above prepolymerization catalyst for olefin polymerization.

Use of the reactor of the present invention makes it possible to prevent fouling on the inner wall surface of the reactor to make it free from damage. It is also possible according to the present invention to produce the prepolymerization catalysts for olefin polymerization and the olefin polymers which have no possibility of causing degradation of quality of the molded products obtained by molding even an olefin polymer mixed with the scraped-off fragments formed by the scraper.

### BRIEF DESCRIPTION OF THE DRAWINGS

FIG. 1 is a front view (schematic diagram) showing an embodiment of the reactor for producing prepolymerization catalysts for olefin polymerization according to the present invention.

FIG. 2 is a top view (schematic diagram) showing another embodiment of the reactor for producing prepolymerization catalysts for olefin polymerization according to the present invention.

FIG. 3 is a front view (schematic diagram) showing still another embodiment of the reactor for producing prepolymerization catalysts for olefin polymerization according to the present invention.

FIG. 4 is a front view (schematic diagram) showing yet another embodiment of the reactor for producing prepolymerization catalysts for olefin polymerization according to the present invention.

### DETAILED DESCRIPTION OF THE INVENTION

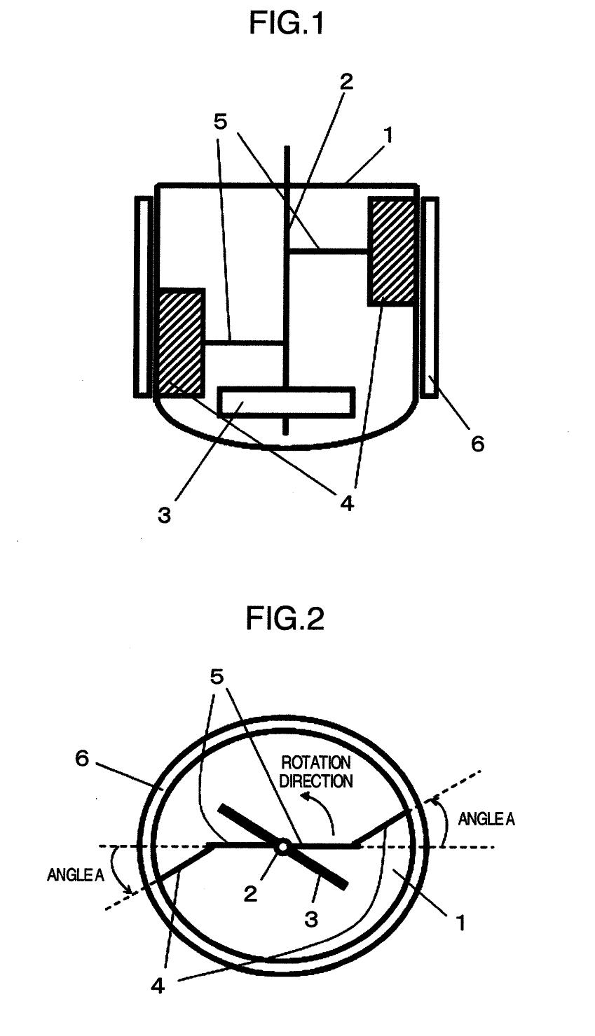

The embodiments of the present invention are described in detail with reference to the accompanying drawings (FIGS. 1 to 4) in the following.

The reactor for producing the prepolymerization catalysts for olefin polymerization according to the present invention comprises a stirring vessel (1), a stirring shaft (2), a stirring blade (3), a scraper (4), a scraper support (5), and a jacket (6). The stirring vessel (1) is substantially columnar, and the stirring shaft (2) is mounted vertically passing through the upper side of the stirring vessel (1). Stirring blade (3) is secured to stirring shaft (2), and each scraper (4) is also fixed to stirring shaft (2). Scraper (4) is secured to stirring shaft (2) through the medium of scraper support (5). Jacket (6) is adapted on the outside of stirring vessel (1).

In accordance with rotation of stirring shaft (2), stirring blade (3) and scrapers (4) fixed to stirring shaft (2) are caused to rotate accordingly in the inside of stirring vessel (1). Stirring shaft (2) may be designed to rotate in the opposite direction. With rotation of scrapers (4), the foulings on the inner wall surface of stirring vessel (1) are scraped off. It is satisfactory if the scrapers are simply designed to be able to scrape off foulings as desired. Scrapers (4) may or may not be in contact with the inner wall surface of stirring vessel (1), but in view of the their effects to lessen the amount of fouling on the inner wall surface of stirring vessel (1) to prevent fouling, scrapers are preferably in contact with the inner wall surface of stirring vessel (1).

Each scraper (4) can be fixed to scraper support (5) in whatever manner if it is capable of scraping off the foulings. For the purpose of lessening the foulings on the inner wall surface of the stirring vessel (1) to prevent fouling, scrapers (4) are preferably mounted so that they will position ahead of scraper support (5) relative to direction of rotation of scrapers (4).

The angle formed by each scraper (4) with scraper support (5) (angle A shown in FIG. 2) is preferably in a range from 0° to 89°. The angle formed by scraper (4) with scraper support (5) is an angle measured in the direction of rotation of scraper (4) from scraper support (5).

From the viewpoint of preventing fouling, scrapers (4) are preferably mounted so that they will be capable of scraping off the fouling on the inner wall surface of stirring vessel (1) covering the whole area where jacket (6) is adapted.

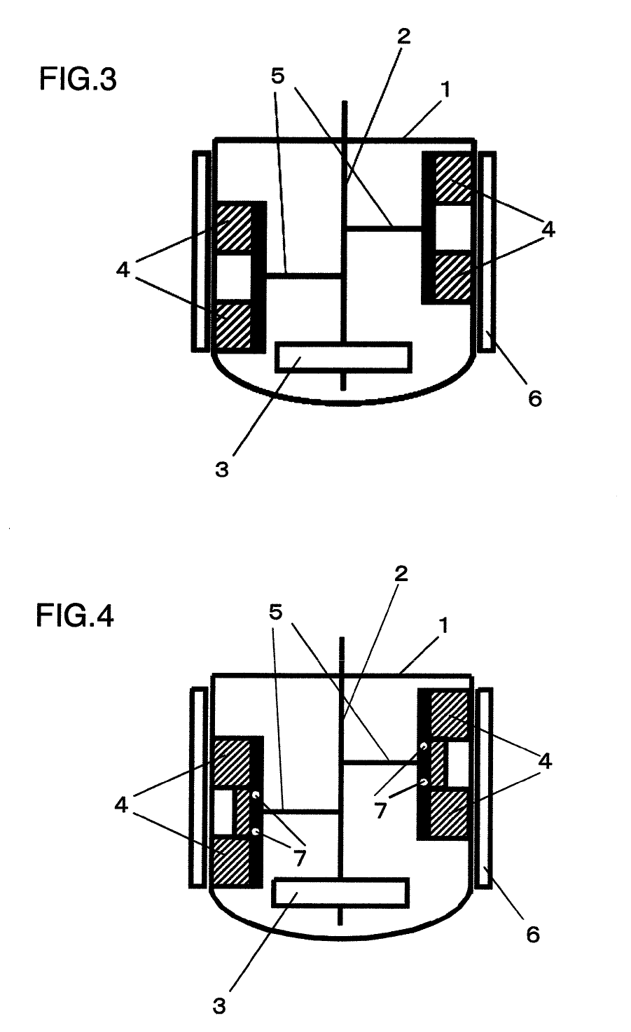

A plural number of scrapers (4) can be mounted on one support (5) as shown in FIG. 3.

In order to reduce fouling on the inner wall surface of stirring vessel (1) and prevent fouling by averting deformation of scrapers (4) and facilitating contact of scrapers (4) with the inner wall surface of stirring vessel (1), the fixtures for fixing scrapers (4) to scraper supports (5) are preferably set at the positions close to both ends of each scraper (4) in its vertical direction. In case where scrapers (4) have a configuration shown in FIG. 4, to the same end as said above, the fixtures for fixing scrapers (4) to scraper supports (5) are preferably not positioned on the extension line in the horizontal direction of the portion contacting the inner wall surface of stirring vessel (1).

In case where a plural number of scraper supports (5) are provided on stirring shaft (2), scraper supports (5) are preferably arranged symmetrically when stirring vessel (1) is viewed from above, for the purpose of protecting stirring shaft (2).

In order to let scrapers (4) contact evenly with the inner wall surface of stirring vessel (1), the length of the portion of each scraper (4) contacting the inner wall surface of stirring vessel (1) is preferably not greater than 100 cm, more preferably not greater than 50 cm, even more preferably not greater than 25 cm, most preferably not greater than 20 cm.

The configuration of scrapers (4) is designed so as not to cause excess driving load of the stirring motor operating to rotate the scrapers through contact with the inner wall of the reactor and to ensure stable operation of the system.

A portion of the scraper for scraping off at least the fouling in the reactor according to the present invention is made of a polyolefin. In view of the fact that even if the fragments formed from damaged scrapers get mixed in the prepolymerization catalyst for olefin polymerization produced by the reactor of the present invention and then further get mixed in the olefin polymers produced by using a prepolymerization catalyst such as mentioned above, the molded product obtained by molding such an olefin polymer is not degraded in its quality, the polyolefin used in the portion of the scraper for scraping off at least the fouling is preferably an olefin polymer of the same type as an olefin polymer produced by using the prepolymeriation catalyst for olefin polymerization. Also, for the same reason, MFR of the polyolefin used in the portion of the scraper for scraping off at least the fouling is in a range from 0.05 g/10 min. to 10 g/10 min. inclusive.

The polyolefin used in the portion of the scraper for scraping off at least the fouling can comprise a single polymer of one type of olefin or a copolymer of two or more different olefins.

The process for producing prepolymerization catalysts for olefin polymerization according to the present invention is a method for producing the pre-polymerization catalysts for olefin polymerization using the reactor provided according to the present invention.

The “prepolymerization catalysts for olefin polymerization” referred to in the present invention are the catalysts in which an olefin has been prepolymerized on the prepolymerization catalyst components for olefin polymerization.

The solid catalysts for olefin polymerization used in the present invention can be known solid catalysts for polymerization usable for olefin polymerization, which include, for example, metallocene catalysts, Ziegler catalysts, Phillips catalysts and the like, with metallocene catalysts preferred. Examples of metallocene catalysts are those formed by contacting a cocatalyst, a metallocene compound and an organoaluminum compound.

Examples organoaluminum compounds usable for the above contact reaction include: trialkylaluminum such as trimethylaluminum, triethylaluminum, tri-n-propylaluminum, tri-n-butylaluminum, triisobutylaluminum, tri-n-hexylaluminum, and tri-n-octylaluminum; dialkylaluminum chlorides such as dimethylaluminum chloride, diethylaluminum chloride, di-n-propylaluminum chloride, di-n-butylaluminum chloride, diisobutylaluminum chloride and di-n-hexylaluminum chloride; alkylaluminum dichlorides such as methylaluminum dichloride, ethylaluminum dichloride, n-propylaluminum dichloride, n-butylaluminum dichloride, isobutylaluminum dichloride, and n-hexylaluminum dichloride; dialkylaluminum hydrides such as dimethylaluminum hydride, diethylaluminum hydride, di-n-propylaluminum hydride, di-n-butylaluminum hydride, diisobutylaluminum hydride, and di-n-hexylaluminum hydride; alkyl(dialkoxy)aluminums such as methyl(dimethoxy)aluminum, methyl(dimethoxy)aluminum, methyl(diethoxy)aluminum, and methyl(di-tert-butoxy)aluminum; alkyl(dialkoxy)aluminums such as methyl(dimethoxy)aluminum, methyl(diethoxy)aluminum, and methyl(di-tert-butoxy)aluminum; alkyl(diaryloxy)aluminums such as methyl(diphenoxy)aluminum, methylbis(2,6-diisopropylphenoxy)aluminum, and methylbis(2,6-diphenylphenoxy)aluminum; and dialkyl(aryloxy)aluminums such as dimethyl(phenoxy)aluminum, dimethyl(2,6-diisopropylphenoxy)aluminum, and dimethyl(2,6-diphenylphenoxy)aluminum. Of these organoaluminum compounds, trialkylaluminum is preferred, trimethylaluminum, triethylaluminum, tri-n-butylaluminum, triisobutylaluminum, tri-n-hexylaluminum or tri-n-octylaluminum is more preferred, and triisobutylaluminum or tri-n-octylaluminum is especially preffered.

These organoaluminum compounds can be used singly or by combining two or more of them.

In the present invention, the term “prepolymerization” means an operation of polymerizing a small quantity of an olefin on the components of a solid catalyst for olefin polymerization to form an olefin polymer on the catalyst components.

The olefins usable for the process for producing prepolymerization catalysts for olefin polymerization according to the present invention include ethylene, propylene, 1-butene, 1-pentene, 1-hexene, 1-heptene, 1-octene, 4-methyl-1-pentene, cyclopentene, cyclohexene, and the like. These olefins can be used either singly or as a combination of two or more of them. Preferably, ethylene alone or a combination of ethylene and an α-olefin is used. More preferably, ethylene alone or a combination of ethylene with at least one α-olefin selected from 1-butene, 1-hexene and 1-octene is used.

The content of the prepolymerized olefin polymer in the prepolymerization catalyst is usually preferably from 0.01 to 1,000 g, more preferably from 0.05 to 500 g, even more preferably from 0.1 to 200 g, per gram of the solid catalyst components.

Either continuous or batchwise polymerization method can be employed for producing the prepolymerization catalysts for olefin polymerization. For example, a batchwise slurry polymerization method or a continuous slurry polymerization method can be used.

For feeding the solid catalyst components to the reactor of the present invention, there is usually employed a method in which feeding is conducted in an anhydrous state using an inert gas such as nitrogen or argon, hydrogen, ethylene or such, or a method in which each component is dissolved in a solvent and supplied in the form of solution or slurry.

When a prepolymerization catalyst for olefin polymerization is produced by a slurry polymerization method using the reactor of the present invention, usually a saturated aliphatic hydrocarbon compound, such as propane, normal butane, isobutene, normal pentane, isopentane, normal hexane, cyclohexane, heptane or the like is used as solvent. These solvents can be used alone or by combining two or more of them. The saturated aliphatic hydrocarbon compounds used in the present invention are preferably those having a boiling point of 100° C. or lower under normal pressure, more preferably those having a boiling point of 90° C. or lower under normal pressure, and use of propane, normal butane, isobutane, normal pentane, isopentane, normal hexane or cyclohexane is even more prefereble.

Prepolymerization temperature is usually from −20° C. to +100° C., preferably from 0 to 80° C. Prepolymerization temperature may be changed properly throughout prepolymerization process. Partial pressure of olefins in the gas phase section during prepolymerization operation is usually from 0.001 to 2 MPa, preferably from 0.01 to 1 MPa. Prepolymerization time is usually from 2 minutes to 15 hours.

The process for producing olefin polymers according to the present invention comprises preparation of the objective olefin polymers by using a prepolymerization catalyst for olefin polymerization produced by the prepolymerization catalyst producing process according to the present invention.

“Olefin polymers” in the present invention are the polymers obtained by polymerizing olefins with a prepolymerization catalyst for olefin polymerization.

“Polymerization” in the present invention is a process for polymerizing olefins with a prepolymerization catalyst for olefin polymerization.

In the present invention, the form of polymerization can be either homopolymerization or copolymerization, and the polymers produced can be either homopolymers or copolymers.

The methods for producing olefin polymers according to the present invention include, for instance, gas phase polymerization, slurry polymerization and bulk polymerization. Gas phase polymerization is preferable, and continuous gas phase polymerization is more preferable.

The gas phase polymerization reaction system used in the process for producing olefin polymers according to the present invention is usually a gas phase fluidized bed reactor, preferably a gas phase fluidized bed reactor having an enlarged portion. A stirring blade can be set in the reactor.

For feeding a prepolymerization catalyst for olefin polymerization or other catalyst components into the polymerization reaction system, there is usually employed a method in which feeding is conducted in an anhydrous state using an inert gas such as nitrogen and argon, hydrogen, ethylene or the like, or a method in which each component is dissolved in a solvent and supplied in the form of solution or slurry.

Polymerization temperature for gas phase polymerization of olefins is usually not higher than the temperature at which olefin polymers are dissolved, preferably from 0 to 150° C., more preferably from 30 to 100° C. An inert gas can be introduced into the polymerization reaction system. Hydrogen can be introduced as a molecular weight modifier. It is also possible to introduce an organoaluminum compound or an electron donative compound.

Polymerization pressure can be anywhere in the range where olefins can exist as gas phase in the gas phase fluidized bed reaction system, but it is usually from 0.1 to 5.0 MPa, preferably from 1.5 to 3.0 MPa. Gas flow rate in the reaction system is usually from 10 to 100 cm/sec, preferably from 20 to 70 cm/sec. Prepolymerization catalyst for olefin polymerization used for gas phase polymerization of olefins is used in an amount within the range where the solid catalyst components contained in the prepolymerization catalyst for olefin polymerization are usually 0.00001 to 0.001 g per gram of olefin.

Olefins used for the process for producing olefin polymers according to the present invention include ethylene, α-olefins and other types of olefins.

α-Olefins are typically those having a carbon number of 3 to 20, such as propylene, 1-butene, 1-pentene, 1-hexene, 1-heptene, 1-octene, 1-nonene, 1-decene, 1-dodecene, 4-methyl-1-pentene, and 4-methyl-1-hexene.

These olefins can be used either singly or by combining two or more of them. Preferred of these olefins for use in the present invention are ethylene, 1-butene, 1-hexene, 4-methyl-1-pentene, and 1-octene.

Other types of olefins include diolefins, cyclic olefins, alkenyl aromatic hydrocarbons, and α,β-unsaturated carboxylic acids. More specific examples of other types of olefins are diolefins such as 1,5-hexadiene, 1,4-hexadiene, 1,4-pentadiene, 1,7-octadiene, 1,8-nonadiene, 1,9-decadiene, 4-methyl-1,4-hexadiene, 5-methyl-1,4-hexadiene, 7-methyl-1,6-octadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 5,8-endomethylenehexahydronaphthalene, 1,3-octadiene, isoprene, 1,3-hexadiene, 1,3-octadiene, 1,3-cyclooctadiene, and 1,3-cyclohexadiene; cyclic olefins such as cyclopentene, cyclohexene, norbornene, 5-methylnorbornene, 5-ethylnorbornene, 5-butylnorbornene, 5-phenylnorbornene, 5-benzylnorbornene, tetracyclododecene, tricyclodecene, tricycloundecene, pentacyclopentadecene, pentacyclohexadecene, 8-methyltetracyclododecene, 8-ethyltetracyclododecene, 5-acetylnorbornene, 5-acetyloxynorbornene, 5-methoxycarbonylnorbornene, 5-ethoxycarbonylnorbornene, 5-methyl-5-methoxycarbonylnorbornene, 5-cyanonorbornene, 8-methoxycarbonyltetracyclododecene, 8-methyl-8-tgetracyclododecene, and 8-cyanotetracyclododecene; alkenylbenzenes such as styrene, 2-phenylpropylene, 2-phenylbutene, and 3-phenylpropylene; alkylstyrenes such as p-methylstyrene, m-methylstyrene, o-methylstyrene, p-ethylstyrene, m-ethylstyrene, o-ethylstyrene, 2,4-dimethylstyrene, 2,5-dimethylstyrene, 3,4-dimethylstyrene, 3,5-dimethylstyrene, 3-methyl-5-ethylstyrene, p-tertiary butylstyrene, and p-secondary butylstyrene; bisalkenybenzenes such as divinylbenzene, alkenyl aromatic hydrocarbons such as alkenylnaphthalene such as 1-vinylnaphthalene; α,β-unsaturated carboxylic acids such as acrylic acid, methacrylic acid, fumaric acid, maleic anhydride, itaconic acid, itaconic anhydride, and bicycle(2,2,1)-5-heptene-2,3-dicarboxylic acid; metal salts such as sodium, potassium, lithium, zinc, magnesium, calcium, etc., of α,β-unsaturated carboxylic acids; α,β-unsaturated carboxylic acid alkyl esters such as methyl acrylate, ethyl acrylate, n-propyl acrylate, isopropyl acrylate, t-butyl acrylate, 2-ethylhexyl acrylate, methyl methacrylate, ethyl methacrylate, n-propyl methacrylate, isopropyl methacrylate, n-butyl methacrylate, and isobutyl methacrylate; unsaturated dicarboxylic acids such as maleic acid and itaconic acid; vinyl esters such as vinyl acetate, vinyl propionate, vinyl caproate, vinyl caprate, vinyl laurate, vinyl stearate, and vinyl trifluoroacetate; and unsaturated carboxylic acid glycidyl esters such as glycidyl acrylate, glycidyl methacrylate, and monoglycidyl itaconate.

In case the olefin polymers presented according to the present invention are ethylene/α-olefin copolymers, the following may be cited as examples of possible combinations of ethylene and α-olefins: ethylene/1-butene, ethylene/1-hexene, ethylene/4-methyl-1-pentene, ethylene/1-octene, ethylene/1-butene/1-hexene, ethylene/1-butene/4-methyl-1-pentene, ethylene/1-butene/1-octene, and ethylene/1-hexene/1-octene. The combinations of ethylene/1-hexene, ethylene/4-methyl-1-pentene, ethylene/1-butene/1-hexene, ethylene/1-butene/1-octene, and ethylene/1-hexene/1-octene are preferred. If necessary, other olefins may be copolymerized.

### EXAMPLES

Measurements of the respective items in the Examples were made by the methods described below.

(1) Density (Unit: kg/m³)

Density was measured by the method specified as A method in JIS K7112-1980. The samples were subjected to annealing prescribed in JIS K6760-1995.

(2) Melt Flow Rate (MFR, Unit: g/10 min)

MFR was measured by the method prescribed in JIS K7210-1995 under the conditions of 21.18 N of load and 190° C. of temperature.

### Example 1

(1) Preparation of Solid Catalyst Components for Olefin Polymerization

24 kg of toluene as solvent and 2.81 kg of silica (Sylopol 948, produced by Devison Co., Ltd.; average particle size=55 μm, pore volume=1.67 ml/g, specific surface area=325 m²/g), which had been heat treated at 300° C. under circulation of nitrogen, were supplied into and stirred in an N-substituted reactor. Then, after cooling the mixture to 5° C., a mixed solution of 0.91 kg of 1,1,1,3,3,3-hexamethyldisilazane and 1.43 kg of toluene were added dropwise over a period of 32 minutes while maintaining the reactor temperature at 5° C. After dropwise addition was completed, the mixture was further stirred for one hour at 5° C. and 3.3 hours at 95° C. The resulting solid product was washed 6 times with 21 kg of toluene. Then 7.1 kg of toluene was added and the product was allowed to stand overnight to yield a toluene slurry.

1.75 kg of a 50 wt % hexane solution of diethylzinc and, as solvent, 1.0 kg of hexane were supplied to the toluene slurry and stirred. Then, after the mixture has been cooled to 5° C., a mixed solution of 0.78 kg of trifluorophenol and, as solvent, 1.41 kg of toluene was added dropwise over a period of 61 minutes while maintaining the reactor temperature at 5° C. After completion of dropwise addition, the mixture was stirred at 5° C. for one hour and at 40° C. for another one hour. Then, after the temperature has lowered down to 22° C., 0.11 kg of water was added dropwise over a period of 1.5 hour while maintaining the reactor temperature at 5° C. After dropwise addition, the mixture was stirred for 1.5 hour at 22° C., 2 hours at 40° C. and another 2 hours at 80° C. After stopping stirring, the supernatant was pipette off until the residual amount of solution became 16 liters. Then 11.6 kg of toluene was supplied and stirred. The solution was heated to 95° C. and stirred for 4 hours. The resultant solid product was washed 4 times with 20.8 kg of toluene and 3 times with 24 liters of hexane. The product was dried to obtain a solid catalyst component for olefin polymerization. The results of elemental analysis showed: Zn content=11 wt %; Si content=30 wt %; F content=5.9 wt %; N content=2.3 wt %.

(2) Prepolymerization

Prepolymerization was conducted as described below using a reactor shown in FIGS. 1 and 2 provided with 3 mm thick and vertically 15 cm long scrapers made of an ethylene-1-butene/1-hexene copolymer with MFR of 0.9 g/10 min and a density of 918 kg/m³. Each scraper was set to form an angle of 30° with scraper support.

80 liters of butane was supplied at normal temperature into a preliminarily N-substituted reactor (internal volume=210 liters), after which 34.8 mmol of racemic-ethylenebis(1-indenyl)zirconium diphenoxide was supplied. Then the temperature in the reactor was raised to 50° C., followed by 2-hour stirring. Then the temperature in the reactor was dropped to 30° C. and 0.1 kg of ethylene was supplied, after which 701 g of the solid catalyst component for olefin polymerization obtained in Example 1(1) described above was supplied. Then 0.1 liter of hydrogen was fed under the condition of normal temperature and normal pressure. After the system has been stabilized, 140 mmol of triisobutylaluminum was supplied to initiate prepolymerization. The stirring blade and the scrapers were designed to operate interlocked with each other. They were rotated at a speed of 108 rpm.

After start of prepolymerization, prepolymerization temperature in the reactor was set at 30° C. and prepolymerization was carried out for 0.5 hour. Then temperature was raised to 50° C. over a period of 30 minutes and prepolymerization was conducted at 50° C. In the first 0.5 hour after start of prepolymerization, ethylene was supplied at a rate of 0.7 kg/hr while hydrogen, adjusted to normal temperature and normal pressure, was fed at a rate of 0.8 l/hr. After the lapse of 0.5 hour from start of prepolymerization, ethylene was supplied at a rate of 3.2 kg/hr while hydrogen, adjusted to normal temperature and normal pressure, was fed at a rate of 9.5 l/hr, thus conducting prepolymerization for a total period of 6 hours. After the end of prepolymerization, reactor internal pressure was purged down to 0.5 MPaG, and the slurry-like preparation of prepolymerization catalyst for olefin polymerization was transferred into a dryer where drying was carried out under circulation of nitrogen to obtain a prepolymerization catalyst for olefin polymerization. The prepolymerization rate of the ethylene polymer in the prepolymerization catalyst for olefin polymerization was 21.9 g per gram of the solid catalyst components for olefin polymerization.

Prepolymerization was carried out 7 times in the same way as described above. As a result, decline of heat removal effect by fouling was small, and almost no fouling was seen on the inner wall surface of the stirring vessel which were in contact with the scrapers.

(3) Fluidized Bed Gas Phase Polymerization

Using a gas phase fluidized bed reaction system, ethylene and 1-hexene copolymerization was carried out under the following conditions: polymerization temperature=86° C.; pressure=2.0 MPaG; amount of hold up=80 kg; gas composition=86.0 mol % ethylene, 1.1 mol % hydrogen, 1.1 mol % 1-hexene, 11.5 mol % nitrogen, and 0.3 mol % hexane; circulating gas flow rate=31 cm/sec.

In the polymerization operation, the prepolymerization catalyst for olefin polymerization obtained in Example 1(2) described above was supplied at a rate of 59.2 g/hr. Also, in the polymerization, triethylamine and triisobutylaluminum were supplied to the polymerization reactor at the rates of 0.6 mmol/hr and 20 mmol/hr, respectively, to produce an ethylene/1-hexene copolymer at an average rate of 21.4 kg/hr. Dispersion rate was 1.1 wt ppm, and there was observed almost no formation of masses. The obtained ethylene/1-hexene copolymer had a density of 919.2 kg/m³ and its MFR was 0.72 g/10 min.

Also, the fish eyes formed in the film made of this polymer were small in number.

### Example 2

(1) Prepolymerization

Prepolymerization was carried out as follows using a reactor provided with a plural number of scrapers, each having a thickness of 3 mm and a vertical length of 15 cm, which were made of an ethylene-1-butene/1-hexene copolymer with MFR of 0.9 g/10 min and a density of 918 g/m³. The angle formed by each scraper with scraper support was set at 30°.

Then prepolymerization was executed using the same catalyst and slurry density as used in Example 1 (1) and (2). The stirring blade and scrapers were interlocked with each other and rotated at a speed of 60 rpm. Prepolymerization was carried out 6 times in this way. As a result, heat removal effect by fouling was limited, and there was seen almost no fouling on the inner wall surface of the stirring vessel in contact with the scrapers.

### Example 3

(1) Prepolymerization

Prepolymerization was carried out as follows using a reactor shown in FIG. 2 provided with a plural number of 3 mm thick and vertically 15 cm long scrapers made of an ethylene/1-butene/1-hexene copolymer with MFR of 0.9 g/10 min and density of 918 kg/m³. Each scraper and scraper support were set to form an angle of 330°.

Then prepolymerization was performed with the same catalyst and slurry concentration as used in Example 1 (1) and (2). The stirring blade was interlocked with the scrapers and rotated at a speed of 60 rpm. Prepolymerization was conducted 4 times in this way. Fouling occurred slightly, and fouling existed only sparsely on the inner wall surface of the stirring vessel, but reduction of heat removal effect by fouling was small.

### Example 4

(1) Prepolymerization

Following prepolymerization was carried out using a reactor shown in FIG. 2 having a plural number of 3 mm thick and vertically 56 cm long scrapers made of an ethylene/1-butene/1-hexene copolymer with MFR of 0.9 g/10 min and a density of 918 g/m³. Each scraper and scraper support were set to form an angle of 330°.

Then prepolymerization was conducted with the same catalyst and slurry concentration as used in Example 1 (1) and (2). The stirring blade was interlocked with the scrapers and rotated at a speed of 60 rpm. Prepolymerization was performed 4 times in the above-described way. There took place slightly more fouling than in Example 3, and the fouling was seen present sparsely on the inner wall surface of the stirring vessel, but fall of heat removal effect by fouling was small.

### Comparative Example 1

(1) Prepolymerization

Prepolymerization was carried out in the same way as in Example 1 (1) and (2), with the scrapers removed.

Reduction of heat removing performance due to fouling was great, and after 4 times of prepolymerization, it became necessary to conduct open cleaning for removing fouling matters adhering to the inner wall surface of the stirring vessel.

### INDUSTRIAL APPLICABILITY

By using the reactor according to the present invention, it is possible to prevent fouling on the inner wall surface of the reactor and to produce the prepolymerization catalysts for olefin polymerization and the olefin polymers which hardly cause damage on the inner wall surface of the reactor, and also according to the present invention, even if the broken fragments of the scrapers get mixed in the olefin polymers during molding operation, the molded products would not be degraded in quality. Therefore, the present invention finds useful application to the field of production of olefin polymers.

We claim:

1. A reactor for producing a prepolymerization catalyst for olefin polymerization, said reactor comprising:
a stirring blade; and
a scraper,
wherein said scraper is capable of scraping off a fouling adhered on an inner wall surface of the reactor, and
a portion of the scraper for scraping off at least said fouling is made of a polyolefin.

2. The reactor according to claim 1, wherein the polyolefin used in the portion of the scraper for scraping off at least said fouling is an olefin polymer of the same type as an olefin polymer produced by using the prepolymerization catalyst for olefin polymerization.

3. The reactor according to claim 1, wherein an angle formed by the scraper with a scraper support is from 0° to 89°.

4. The reactor according to claim 1, wherein a length of a portion of the scraper contacting the inner wall surface of a stirring vessel is not greater than 100 cm.

5. The reactor according to claim 1, wherein MFR of the polyolefin used in the portion of the scraper for scraping off at least said fouling is from 0.05 g/10 min to 10 g/10 min.

6. A method for producing a prepolymerization catalyst for olefin polymerization by using the reactor according to claim 1.

7. A method for producing an olefin polymer by using the prepolymerization catalyst for olefin polymerization according to claim 6 and by using a gas phase fluidized bed reaction system.

8. The method for producing an olefin polymer according to claim 7, wherein the olefin polymer is an ethylene polymer.
